(19) United States
(12) Patent Application Publication
(10) Pub. No.: US 2023/0416658 A1
(43) Pub. Date: Dec. 28, 2023

(54) COMPOSITIONS COMPRISING PROTONATED TRIAZACYCLIC COMPOUNDS AND MANGANESE(II) ACETATE, MANUFACTURING THEREOF, AND BLEACHING AND CLEANING AGENT COMPRISING SAME

(71) Applicant: WEYLCHEM PERFORMANCE PRODUCTS GMBH, Wiesbaden (DE)

(72) Inventors: Ronald Hage, Leiden (NL); Yfranka Roelofsen, Hazerswoude-Rijndijk (NL); Judith Preuschen, Sörgenloch (DE); Rolf Ludwig, Eppstein (DE); Paul Kaufmann, Hochheim (DE)

(21) Appl. No.: 18/211,863

(22) Filed: Jun. 20, 2023

(30) Foreign Application Priority Data
Jun. 24, 2022 (EP) 22000171.3

(51) Int. Cl. C11D 17/06; C11D 11/00; C11D 3/20; C11D 3/34; C11D 3/22; C11D 3/33; C11D 3/37; C11D 3/395

(52) U.S. Cl. CPC C11D 17/06; C11D 11/0023; C11D 11/0082; C11D 3/2079; C11D 3/349; C11D 3/222; C11D 3/33; C11D 3/3753; C11D 3/3951; C11D 3/3953

(57) ABSTRACT

The present invention concerns a composition comprising Mn(II) acetate, a protonated salt of a cyclic triamine, a polysaccharide absorbent, and a water-soluble polymer, e.g. polyvinylalcohol. The invention also concerns a method of making such compositions, preferably in the form of a granule, and bleaching formulations comprising the salt and a peroxy compound or precursor thereof. The protonated ligand salt and Mn(II) acetate containing composition and formulations comprising it, are suitable for use in catalysing oxidation, for example as a component of a laundry or dishwasher bleaching composition. The invention further relates to cleaning agents comprising the compositions described herein.

### CLAIM FOR PRIORITY

This application is a national phase application of EP application 22000171.3 filed Jun. 24, 2022, the priority of which is hereby claimed and its disclosure incorporated herein by reference.

### FIELD OF THE INVENTION

The present invention concerns compositions that comprise a protonated cyclic triamine compound, manganese(II) acetate and other ingredients.

The invention also concerns bleaching formulations comprising said granules and a peroxy compound or a precursor thereof. The granules and formulations comprising said granules are suitable for use in catalysing oxidation or bleaching, for example as a component of an automatic dishwasher bleaching composition.

### BACKGROUND

Manganese catalysts based on triazacyclononane ligands are known to be active catalysts in the bleaching of stains in laundry detergent products and in dishwash products and for treatment of cellulosic substrates in e.g. wood-pulp or raw cotton (see for example EP 0 458 397 A2 (Unilever NV and Unilever plc) and WO 2006/125517 A1 (Unilever plc et al.).

Since these catalysts are very effective, only small amounts of them need to be used in bleaching detergent or dishwash formulations, often at levels less than 0.1 wt % in the detergent or dishwasher formulation. A difficulty arising from the use of such low dosing is achieving accurate dosing of the catalyst and homogeneous distribution throughout the formulation. When distribution of the catalyst is heterogeneous in a formulation, the use of such detergent formulations in a washing machine or in handwashing can lead to underdosing (i.e. giving a poorer bleaching performance) or overdosing of the catalyst (i.e. giving rise to excessive hydrogen peroxide decomposition and possibly brown spotting). A well-known approach to circumvent this potential problem is the presentation/inclusion of the solid catalyst on a solid support in bleaching formulations. Non-limiting examples of approaches to develop stable granules comprising bleach catalyst compositions are EP 0 544 440 A2, WO 94/21777 A1, WO 95/06710 A1 (all Unilever N.V. and Unilever plc), WO2018/011596 (Itaconix Ltd), WO2018/210442 (Weylchem Wiesbaden GmbH), EP3167036B and WO2016/177439 (both Novozymes A/S), EP2966161A and WO2017/118543 (both Dalli Werke GmbH).

In general, a disadvantage of the approach of using granules comprising the manganese bleach catalysts is that these will be intensely coloured. For example the granules of [Mn^{IV}Mn^{IV}(μ-O)₃(Me₃-TACN)₂](PF₆)₂(Me₃-TACN=1,4,7-trimethyl-1,4,7-triazacyclononane) are clearly red/pink coloured which for certain detergent formulations will not be optimal. The advantage of using [Mn^{IV}Mn^{IV}(μ-O)₃(Me₃-TACN)₂](PF₆)₂ is that this complex is relatively stable, thanks to the presence of kinetically slow Mn(IV) ions. Inclusion of palely coloured or even colourless granules would be appealing. In general only Mn(II) salts are (nearly) colourless, but these suffer often from instability during storage, especially in alkaline oxidative environments, which leads to formation of brown MnO₂ matter.

WO2010/022918 A1 (Clariant International Ltd) cover the use of Mn(II) oxalate as bleaching catalysts, which showed enhanced activity compared to other Mn(II) salts. It was observed that the solubility of Mn(II) oxalate in water is very low. In WO2010/022919 A1 (Clariant International Ltd) it was shown that mixtures of various Mn(II) or Mn(Ill) salts with oxalic acid showed a higher cleaning activity than the same Mn salts without oxalic acid.

EP0549271 B1 (Unilever PLC and Unilever N.V.) describe the use of the Me₃-TACN ligand, optionally as a protonated salt, in conjunction with a Mn source, such as Mn(nitrate)₂ or a Mn-Me₃-TACN containing complex to enhance bleaching activity of hydrogen peroxide.

WO2022/122177 A1 (Weylchem Performance Products GmbH) discloses coated granules comprising protonated Me₃TACN and bridged bis-Me₂TACN salts together with Mn(II) oxalate and a polysaccharide absorbent. The experiments disclosed in the patent application showed that only when Mn(II) oxalate (together with the protonated Me₃TACN salt) is present in the coated granule, storage stable granules were obtained, whilst similar coated granule compositions without Mn(II) oxalate, but with either Mn(II) chloride or Mn(II) acetate showed poor stability in dishwash formulations. Also it was shown that including Mn(II) oxalate, protonated Me₃TACN salt and polysaccharide absorbent but now without a coating around the granules, yielded a very poor stability. The inclusion of the coating layer was therefore essential.

While the art of bleaching formulations is continuously progressing, there remains a need of developing further colourless or palely coloured granules that show good storage stability and high bleaching activity. There is especially a need for compositions which can be manufactured by simple processes and which preferably are devoid of a coating. The present invention is intended to address these needs.

### SUMMARY OF THE INVENTION

We have surprisingly found that coated or uncoated granules comprising a protonated cyclic triamine compound, manganese(II) acetate, and other ingredients show very high bleaching activity for useful periods of storage time.

In one embodiment, the use of polysaccharide absorbent, a water-soluble polymer, wherein the water-soluble polymer has a solubility in water of at least 50 g/L at 25° C. and is selected from the classes of poly(vinylpyrrolidone), polyalkylene glycol, poly(vinylalcohol)s, modified poly-(vinylalcohol)s, polyvinyl acetate and homo- or copolymers prepared from ethylenically unsaturated carboxylic acids, such as polyacrylate, Mn(II) acetate, rather than other commercially available Mn(II) salts, in combination with protonated cyclic polyamine compound salts provides storage stable coated or uncoated granules and detergent compositions thereof, yet providing high bleaching activity.

Viewed from a first aspect, therefore, the invention provides an uncoated or coated composition, that comprises a polysaccharide absorbent, a water-soluble polymer, wherein the water-soluble polymer has a solubility in water of at least 50 g/L at 25° C. and is selected from the classes of poly(vinyl-pyrrolidone), polyalkylene glycol, poly(vinylalcohol)s, modified poly-(vinylalcohol)s, polyvinyl acetate and homo- or copolymers prepared from ethylenically unsaturated carboxylic acids, such as polyacrylate, 0.02-25 wt-% Mn(II) acetate, and 0.02-25 wt-% of a salt of composition [HL]⁺(Xⁱ⁻)_{1/i}, [H₂L]²⁺ (Xⁱ⁻)_{2/i}, [H₃L]³⁺ (Xⁱ⁻)_{3/i}, [(HL-BG-LH)]²⁺(Xⁱ⁻)_{2/i}, [(HL-BG-LH₂)]³⁺(Xⁱ⁻)_{3/i}, [(H₂L-BG-LH₂)]⁴⁺(Xⁱ⁻)_{4/i}, [(H₃L-BG-LH₂)]⁵⁺(Xⁱ⁻)_{5/i}, and/or [(H₃L-BG-LH₃)]⁶⁺(Xⁱ⁻)_{6/i}, wherein L is a monocyclic triamine and BG is a divalent organic bridge group linking two L-groups,

i is 1 or 2,

Xⁱ⁻ is a mono- or divalent anion, preferably an anion selected from the group consisting of Cl⁻, Br⁻, I⁻, NO₃⁻, ClO₄⁻, PF₆⁻, BF₄⁻, OCN⁻, SCN⁻, SO₄²⁻, R′SO₄⁻, R′COO⁻, R″oxalate-, oxalate²⁻, CF₃SO₃⁻ and R′SO₃⁻, wherein R′ is selected from hydrogen, C₁-C₈ alkyl, phenyl and methyl substituted phenyl, and wherein R″ is selected from H, Na, K and Li, and, provided the composition contains a coating, said water-soluble polymer is present in the coating for less than 50 wt-%.

L is preferably a monocyclic triamine and L-BG-L is preferably two monocyclic triamines linked via a divalent organic bridge group, more preferred L is a monocyclic triamine of formula (1) and L-BG-L is a dicyclic triamine of formula (2):

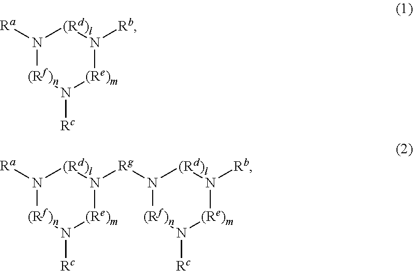

wherein R^{a}, R^{b} and R^{c} independently of one another are hydrogen, alkyl or aryl which may be substituted with alkyl, alkoxy, hydroxyl, sulfo or carboxyl groups or with halogen atoms,
R^{d}, R^{e} and R^{f} are a —CR^{h}Rⁱ— group,
R^{g} is a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups,
R^{h} and Rⁱ independently of one another are hydrogen, alkyl or aryl which may be substituted with alkyl, alkoxy, hydroxyl, sulfo or carboxyl groups or with halogen atoms, and
l, m and n independently of one another are 1, 2, 3 or 4.

Most preferred L is a ring of formula (I) and L-BG-L is two rings of formula (I) linked via an organic divalent group RB:

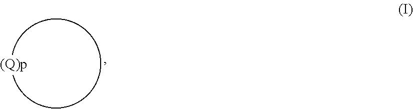

wherein:

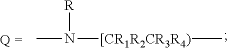

p is 3;

R is independently selected from the group consisting of hydrogen, C₁-C₂₄alkyl, CH₂CH₂OH and CH₂COOH; or one R is linked as a divalent group RB to the nitrogen atom of another Q of another ring of formula (I), wherein RB is selected from a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups;

R¹, R², R³, and R⁴ are independently selected from H, C₁-C₄alkyl and C₁-C₄-alkylhydroxy.

Viewed from a second aspect, the invention provides a method of manufacturing said compositions, preferably as granules, said method comprising
a) providing in a mixing device a composition containing a water-soluble polymer, wherein the water-soluble polymer has a solubility in water of at least 50 g/L at 25° C. and is selected from the classes of poly(vinyl-pyrrolidone), polyalkylene glycol, poly(vinylalcohol)s, modified poly-(vinylalcohol)s, polyvinyl acetate and homo- or copolymers prepared from ethylenically unsaturated carboxylic acids, such as polyacrylate, a polysaccharide absorbent, water, a salt of the composition comprising the ligand of formula (I) defined above and Mn(II) acetate,
b) mixing the ingredients of said composition, and.
c) optionally subjecting said mixture from step b) to a coating operation.

Viewed from a third aspect, the invention provides a bleaching formulation comprising a composition according to the first aspect of the invention.

Viewed from a fourth aspect, the invention provides a method comprising contacting a substrate with water and a bleaching formulation according to the third aspect of the invention.

Further aspects and embodiments of the present invention will be evident from the discussion that follows below.

### DETAILED DESCRIPTION

As summarised above, the present invention is based, in part, on the finding that an uncoated or coated composition, preferably in the shape of a granule that comprises a polysaccharide absorbent, a water-soluble polymer, wherein the water-soluble polymer has a solubility in water of at least 50 g/L at 25° C. and is selected from the classes of poly(vinylpyrrolidone), polyalkylene glycol, poly(vinylalcohol)s, modified poly-(vinylalcohol)s, polyvinyl acetate and homo- or copolymers prepared from ethylenically unsaturated carboxylic acids, such as polyacrylate, Mn(II)acetate, and a salt of composition [HL]⁺(Xⁱ⁻)_{1/i}, [H₂L]²⁺(Xⁱ⁻)_{2/i}, [H₃L]³⁺(Xⁱ⁻)_{3/i}, [(HL-BG-LH)]²⁺(Xⁱ⁻)_{2/i}, [(HL-BG-LH₂)]³⁺(Xⁱ⁻)_{3/i}, [(H₂L-BG-LH₂)]⁴⁺(Xⁱ⁻)_{4/i}, [(H₃L-BG-LH₂)]⁵⁺(Xⁱ⁻)_{5/i}, and/or [(H₃L-BG-LH₃)]⁶⁺(Xⁱ⁻)_{6/i}, wherein L, BG, i and X are as hereto before described, preferably L being a compound of formula (I) or L-BG-L being two compounds of formula (I) linked via a BG group described herein, can be obtained. Said compositions are colourless or palely coloured, exhibit high bleaching activity in detergent formulations comprising a peroxy compound and exhibit high stability in detergent formulations upon storage, even as uncoated variants of the compositions.

The composition of the first aspect of the invention comprises a polysaccharide absorbent, a water-soluble polymer, wherein the water-soluble polymer has a solubility in water of at least 50 g/L at 25° C. and is selected from the classes of poly(vinylpyrrolidone), polyalkylene glycol, poly(vinylalcohol)s, modified poly-(vinylalcohol)s, polyvinyl acetate and homo- or copolymers prepared from ethylenically unsaturated carboxylic acids, such as polyacrylate, Mn(II) acetate, a salt of a monocyclic triamine compound L or of a compound L-BG-L, preferably of formula (I) or two compounds of formula (I) linked via a BG-group, optionally a processing additive, and in which said composition is optionally coated by a water-soluble coating, said coating containing less than 50% by weight of the water-soluble polymer defined above present in said composition.

The term, “water-soluble” when used in this description is meant to describe a compound which is soluble in water of 25° C. at a concentration of at least 50 g/L, preferably more than 100 g/L and most preferably more than 200 g/L.

The polysaccharide absorbent serves as a processing additive and facilitates the formation of the composition, preferably in the form of granules or absorption of any water that is employed during the mixing of the ingredients to make the composition or the granules.

The water-soluble polymer aids to keep the integrity of the composition, preferably in the form of granules during the storage in detergent formulations.

Mn(II) acetate contains two acetate anions as counterion per manganese(II) ion. Mn(II) acetate may be anhydrous, it may contain crystal water, e.g. 2 water molecules or 4 water molecules in the crystal lattice. Most preferably Mn(II) acetate tetrahydrate is used, i.e. Mn(II)(CH₃COO)₂·4H₂O.

In an embodiment, the composition comprises between 0.02 and 25 wt-% of Mn(II) acetate. Suitably, said composition contains between 0.1 and 10 wt-% of Mn(II) acetate. More suitably, these composition contain between 0.2 and 5 wt-% of Mn(II) acetate.

The cyclic triamine compound L or L-BG-L is protonated when present in the composition of the first aspect of the invention. One of the nitrogen atoms of each polyamine ring can be protonated, i.e. the compound L is in that case monoprotonated. Alternatively, two of nitrogen atoms of each triamine ring can be protonated, i.e. the compound L is then diprotonated. Yet, alternatively, each of the nitrogen atoms can be protonated, i.e. the ligand is in that case triprotonated. The first pKa of 1,4,7-trimethyl-1,4,7-triazacyclononane is 11.7, the second one is 5.1, and the third one is 0.4 (P. Chauduri, K. Wieghardt, Prog. Inorg. Chem., 35, 329-436 (1987)). The compositions that comprise the salts are generally between slightly acidic (like pH 4) and neutral, indicating that mainly the monoprotonated and diprotonated salts will be prevalent in said compositions. The unprotonated compounds L and L-BG-L are very strong bases and would be instable in the compositions of the first aspect of the invention; being a strong base, will be readily protonated to form the monoprotonated salt in the compositions. The triprotonated salt is a very strong acid and would release its third proton readily. Therefore, the triprotonated salt will likely exist only in a small portion if at all in said compositions.

The monoprotonated, diprotonated, or triprotonated triamine ring of the compound of formula L or triamine rings of L-BG-L will have one or more counterions Xⁱ⁻ in order to balance the charge of the monoprotonated or deprotonated compound L or L-BG-L and can be conveniently denoted as [HL]⁺(Xⁱ⁻)_{1/i}, [H₂L]²⁺(Xⁱ⁻)_{2/i}, [H₃L]³⁺(Xⁱ⁻)_{3/i}, [(HL-BG-LH)]²⁺(Xⁱ⁻)_{2/i}, [(HL-BG-LH₂)]³⁺(Xⁱ⁻)_{3/i}, [(H₂L-BG-LH₂)]⁴⁺(Xⁱ⁻)_{4/i}, [(H₃L-BG-LH₂)]⁵⁺(Xⁱ⁻)_{5/i}, and/or [(H₃L-BG-LH₃)]⁶⁺(Xⁱ⁻)_{6/i}. Together they will be called the salt of the compound L or compound L salt, or alternatively the salt of the compound L-BG-L or compound L-BG-L salt

Typically, the cyclic triamine ligand will be monoprotonated or diprotonated, i.e. [HL]⁺, [H₂L]²⁺, [H₃L]³⁺, [(HL-BG-LH)]²⁺, [(HL-BG-LH₂)]³⁺, or [(H₂L-BG-LH₂)]⁴⁺. More typically, the cyclic triamine ligand will be either [HL]⁺ or [H₂L]²⁺. Even more typically, the cyclic triamine ligand will be [H₂L]²⁺.

The identity of the counteranion(s) Xⁱ⁻ is not an essential feature of the invention. However, these will typically be selected from Cl⁻, Br⁻, I⁻, NO₃⁻, ClO₄⁻, PF₆⁻, BF₄⁻, OCN⁻, SCN⁻, SO₄²⁻, R′SO₄⁻, R′COO⁻, R″oxalate⁻, oxalate²⁻, CF₃SO₃⁻ and R′SO₃⁻, whereby R′ is selected from hydrogen, C₁-C₈ alkyl and optionally methyl substituted phenyl, whereby R″ is selected from H, Na, K and Li.

R″oxalate⁻ is a mono-charged counterion, whereby R″ can be hydrogen, i.e. HOOC—COO⁻ (hydrogen oxalate), or an alkali metal ion selected from Li⁺, Na⁺ and K⁺. In case R″oxalate⁻ is present, there will be equal number of mono-anionic R″oxalate⁻ groups present in the ligand salt, depending on the number of protons bound to the triamine ring(s) of L or L-BG-L (like for any mono-charged Xⁱ⁻ group). Thus [HL]⁺ will have one mono-anionic R″oxalate⁻ group as counterion, [H₂L]²⁺ or [(HL-BG-LH)]²⁺ will have two mono-anionic R″oxalate⁻ groups as counterion, [H₃L]³⁺ or [(HL-BG-LH₂)]³⁺ will have three mono-anionic R″oxalate⁻ groups as counterion, [(H₂L-BG-LH₂)]⁴⁺ will have four mono-anionic R″oxalate⁻ groups as counterion, [(H₃L-BG-LH₂)]⁵⁺ will have five mono-anionic R″oxalate⁻ groups as counterion, and [(H₃L-BG-LH₃)]⁶⁺ will have six mono-anionic R″oxalate⁻ groups as counterion.

Oxalate may also be present as its dianion, which is (COO)₂²⁻. There will be then two monoprotonated L compounds ([HL]⁺) with each a charge of 1+ per oxalate²⁻ dianion or in case [H₂L]²⁺ or [(HL-BG-LH)]²⁺ is present there will be one di-anionic oxalate²⁻ group as counterion, [(HL-BG-LH₂)]³⁺ will have 1.5 oxalate²⁻ groups as counterion (or 3 oxalate²⁻ groups per 2 [(HL-BG-LH₂)]³⁺ groups). [(H₂L-BG-LH₂)]⁴⁺ will have then two oxalate²⁻ groups as counterion. [(H₃L-BG-LH₂)]⁵⁺ will have 2.5 oxalate²⁻ groups as counterion (or 5 oxalate²⁻ groups per 2 [(H₃L-BG-LH₂)]⁵⁺ groups). [(H₃L-BG-LH₃)]⁶⁺ will have 3 oxalate²⁻ groups as counterion.

The dianionic oxalate is denoted as oxalate²⁻ when present as counterion of the compound L salt, or the compound L-BG-L salt.

Hydrogen oxalate is the most typical oxalate salt used as counterion for the compound L or L-BG-L salts.

Similarly, the sulfate di-anion is denoted as SO₄²⁻, for the same reasons as outlined for oxalate di-anion as outlined above. Often, the counterion will be selected from Cl⁻, NO₃⁻, hydrogen oxalate, HSO₄⁻, R′COO⁻ and R′SO₃⁻, whereby R′ is selected from alkyl and aryl, preferably from methyl, phenyl and 4-methylphenyl.

More often, the counterions will be selected from the group consisting of Cl⁻, hydrogen oxalate, HSO₄⁻, acetate, and toluene sulfonate.

Particularly often, the counterions will be selected from the group consisting of HSO₄⁻, Cl⁻ and hydrogen oxalate.

According to particular embodiments, each R of the ring of formula (I) is independently selected from the group consisting of hydrogen, C₁-C₂₄alkyl, CH₂CH₂OH and CH₂COOH; or one R is linked to the nitrogen atom of another Q of another ring of formula (I) via an ethylene or a propylene bridge.

According to other embodiments, each R is independently selected from the group consisting of hydrogen, C₁-C₆-alkyl, CH₂CH₂OH and CH₂COOH; or one R is linked to the nitrogen atom of another Q of another ring of formula (I) via an ethylene or a propylene bridge. According to other embodiments, R is independently selected from the group consisting of C₁-C₂₄ alkyl, CH₂CH₂OH and CH₂COOH; or one R is linked to the nitrogen atom of another Q of another ring of formula (I) via an ethylene or a propylene bridge. According to other embodiments, each R is independently selected from CH₃, C₂H₅, CH₂CH₂OH and CH₂COOH. According to other embodiments, each R is independently selected from the group consisting of C₁-C₆-alkyl, in particular methyl; or one R is linked to the nitrogen atom of another Q of another ring of formula (I) via an ethylene or a propylene bridge. Where one R is linked to the nitrogen atom of another Q of another ring of formula (I), this is typically via an ethylene bridge. In such embodiments, the other R groups, including those in the other ring of formula (I), are the same, typically C₁-C₆-alkyl, in particular methyl.

According to further particular embodiments, including each of those particular embodiments described in the immediately preceding paragraph, R₁, R₂, R₃, and R₄ are independently selected from hydrogen and methyl, in particular embodiments in which each of R₁, R₂, R₃, and Rₐ is hydrogen.

When a compound of formula (I) comprises one group R linked to the nitrogen atom (i.e. N) of another Q of another ring of formula (I) via a bridge, it will be understood that such compounds of formula L-BG-L in particular embodiments comprising an ethylene bridge may alternatively be represented by the following structure:

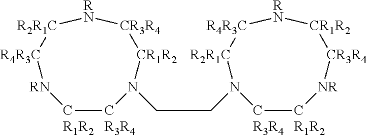

wherein R, R₁, R₂, R₃, and R₄ are as herein defined, including the various specific embodiments set out.

Bridge BG is preferably a C₂-C₆ alkylene bridge, preferably linking two monocyclic polyamines of formula (I). Such alkylene bridges are typically although not necessarily straight chain alkylene bridges as discussed below. They may, however, be cyclic alkylene groups (e.g. the bridge may be cyclohexylene). Where the bridge is a C₆-C₁₀ arylene bridge, this may be, for example, phenylene or the corresponding arylene formed by abstraction of two hydrogen atoms from naphthalene. Where the bridge comprises one or two C₁-C₃ alkylene units and one C₆-C₁₀ arylene unit, such bridges may be, for example, —CH₂C₆H₄CH₂— or —CH₂C₆H₄—. It will be understood that each of these bridges may be optionally substituted one or more times, for example once, with independently selected C₁-C₂₄ alkyl (e.g. C₁-C₁₈ alkyl) groups.

In the compounds L-BG-L, preferably in those with L being a triamine of formula (I), the bridge is typically a C₂-C₆ alkylene bridge. Where this is so, the bridge is typically a straight chain alkylene, e.g. is ethylene, n-propylene, n-butylene, n-pentylene or n-hexylene. According to particular embodiments, the C₂-C₆ alkylene bridge is ethylene or n-propylene. According to still more particular embodiments, the C₂-C₆ alkylene bridge is ethylene. Herein, references to propylene are intended to refer to n-propylene (i.e. —CH₂CH₂CH₂—, rather than —CH(CH₃)CH₂—) unless the context expressly indicates to the contrary.

Examples of preferred compounds L are 1,4,7-triazacyclononanes, 1,4,7-triaza-cyclododecanes, 1,4,8-triazacyclododecanes, 1,4,7-trimethyl-1,4,7-triazacyclo-nonanes and 1,4,7-trimethyl-1,4,7-triazacyclododecanes. At the nitrogen atom and/or at the CH-group these compounds can carry further substituents.

Preferred are the following cyclic polyamines: 1,4,7-triazacyclononane (TACN), 1,4,7-trimethyl-1,4,7-triazacyclononane (1,4,7-Me₃TACN), 2-methyl-1,4,7-triaza-cyclononane (2-MeTACN), 1,4-dimethyl-1,4,7-triazacyclononane, 1,2,4,7-tetra-methyl-1,4,7-triaza-cyclononane (1,2,4,7-Me₄TACN), 1,2,2,4,7-pentamethyl-1,4,7-triazacyclononane (1,2,2,4,7-Me₅TACN), 2-benzyl-1,4,7-trimethyl-1,4,7-triazacyclononane, and 2-decyl-1,4,7-trimethyl-1,4,7-triazacyclononane.

These cyclic triamines can be synthesized in a manner as described, for example, by K. Wieghardt et al. in Inorganic Chemistry 1982, 21, 3086 ff. or in “Macrocyclic Chemistry” of Dietrich, Viout, Lehn, Weinheim 1993.

These cyclic triamines can be transformed into protonated salts by reaction with the corresponding acids.

According to particular embodiments of the invention, the compound L of formula (I) is 1,4,7-trimethyl-1,4,7-triazacyclononane (Me₃-TACN) or the compound L-BG-L is 1,2-bis(4,7-dimethyl-1,4,7-triazacyclonon-1-yl)-ethane (Me₄-DTNE). According to still more particular embodiments of the invention, the compound of formula (I) is Me₃-TACN.

In an embodiment, the composition comprise a polysaccharide absorbent, a water-soluble polymer, and between 0.02 and 25 wt-% of the salt with composition [[HL]⁺(Xⁱ⁻)_{1/i}, [H₂L]²⁺ (Xⁱ⁻)_{2/i}, [H₃L]³⁺ (Xⁱ⁻)_{3/i}, [(HL-BG-LH)]²⁺ (Xⁱ⁻)_{2/i}, [(HL-BG-LH₂)]³⁺ (Xⁱ⁻)_{3/i}, [(H₂L-BG-LH₂)]⁴⁺ (Xⁱ⁻)_{4/i}, [(H₃L-BG-LH₂)]⁵⁺ (Xⁱ⁻)_{5/i}, and/or [(H₃L-BG-LH₃)]⁶⁺ (Xⁱ⁻)_{6/i}, wherein L, BG, i and Xⁱ⁻ are defined above, preferably of the salt of the ligand L or L-BG-L, wherein L is a compound according to formula (I).

More preferred the compositions comprise between 0.1 and 10 wt-% of the salt of the ligand L or L-BG-L, preferably of the compound L or L-BG-L, wherein L is a compound according to formula (I). Still more preferred, the compositions comprise between 0.3 and 6.0 wt-% of the salt of the compound L or L-BG-L, preferably of the compound L or L-BG-L, wherein L is a compound according to formula (I).

Without being bound to theory, the manganese ions that are liberated upon dissolving Mn(II) acetate in water bind to the cyclic triamine (L) salt. If a triprotonated ligand salt is used, the triprotonated ligand salt will lose two protons upon dissolution in mildly alkaline bleaching solutions, to form the monoprotonated compound species. If a diprotonated ligand salt is used, the diprotonated ligand salt will lose one proton upon dissolution in mildly alkaline bleaching solutions, to form the monoprotonated compound species. In case the L-BG-L salt is used, whereby each L group, or one of its L groups, is diprotonated, each L group will lose one proton upon dissolution in mildly alkaline solutions. In case the L-BG-L salt is used, whereby each L group, or one of its L groups, is triprotonated, each L group or of the L groups will lose two protons upon dissolution in mildly alkaline solutions. The monoprotonated compound ([HL]⁺ or [HL-BG-LH]²⁺) will lose its last proton (per polyamine ring) when binding to Mn(II) ions. The Mn-ligand species thus formed will react further with the alkaline hydrogen peroxide solution to form bleach-active Mn-ligand catalyst species.

The water-soluble polymer suitably has a solubility of at least 50 g/L in water at 25° C. More typically, the solubility of the water-soluble polymer in water is at least 100 g/L at 25° C. Most typically, the solubility of the water-soluble polymer is at least 200 g/L at 25° C. in water. This encompasses polymers that are entirely water-soluble as well as those that are substantially water-soluble. It will be appreciated that the solubility of substantially water-soluble polymers may be increased by changes in temperature, pH, or an increase in dilution factor.

The water-soluble polymer has a solubility in water of at least 50 g/L at 25° C. and is selected from the classes of poly(vinylpyrrolidone), polyalkylene glycol, poly(vinylalcohol)s, modified poly-(vinylalcohol)s, polyvinyl acetate, homo- or copolymers from ethylenically unsaturated carboxylic acids, such as poly-(meth)acrylates, polymaleic acid, polyfumaric acid, and polyitaconic acid or poly-(meth)acrylates comprising copolymerized units derived from maleic acid, fumaric acid or itaconic acid.

The water-soluble polymer may be a linear, branched or cross-linked homopolymer or copolymer, or a mixture thereof. Suitable polymers include one or more of poly(vinylpyrrolidone), polyalkylene glycol, ethylenevinylalcohol, and linear, branched or cross-linked polymers or copolymers prepared from one or more of the following monomers: N-vinylpyrrolidone, ethylenically unsaturated carboxylic acid, such as methacrylic acid, acrylic acid, maleic acid, fumaric acid, itaconic acid or 2-acrylamido-2-methyl-1-propanesulfonic acid, or vinyl alcohol or vinyl acetate.

Preferred are poly (vinyl alcohol)s, (such as Mowiol® from Kuraray), functionalised poly (vinyl alcohol)s (including, for example, butyl acetals), polymers such as Kolloidon® or Luvicross® available from BASF, acrylic copolymers such as Arbopol® (homo- and copolymers of acrylic acid cross-linked with a polyalkenyl polyether) or Ultralez 10, 21, 30 or Noveon®AA-1 range from Lubrizol (acrylic acid polymer cross-linked with divinyl glycol), and the Sokalan® range from BASF (polyacrylic acid) such as CP5, CP10 and PA30.

In an embodiment, the water-soluble polymer is selected from the classes of poly(vinylpyrrolidone), polyalkylene glycol, poly(vinylalcohol)s, modified poly-(vinylalcohol)s, such as poly-(ethylenevinylalcohol), or polyvinyl acetate and polyacrylate.

In an embodiment, the water-soluble polymer is poly(vinyl alcohol) (PVOH) or a poly(vinyl alcohol)-based polymer.

Also modified polyvinylalcohol polymers could be used, such as hydrophobic or hydrophilic modified ones. For example, hydrophobic polyvinylalcohol polymers include ethylene-modified ones, such as Exceval® of the firm Kuraray. Also the vinylalcohol groups may be partly modified by reaction with aldehydes, especially C₂-C₁₀ aldehydes as exemplified in WO2018/011596 (Itaconix Ltd.) or different polymer building blocks within one polymer could be used, for example polyvinylalcohol with poly-(meth)acrylate component in the polymer.

The modified residues can be block-like or statistically arranged.

PVOH polymers are typically manufactured by the polymerisation of vinyl acetate to obtain poly(vinyl acetate) (PVAc) followed by hydrolysis of the PVAc.

It will be appreciated that during hydrolysis of the PVAc, a number of the vinyl acetate groups present may remain unhydrolysed in the resulting PVOH polymer. Such polymers, with a mixture of vinyl alcohol units and un-reacted vinyl acetate units, are commonly referred to by the name PVOH by those skilled in the art. The degree of hydrolysis of the PVOH is important in determining its properties.

Optionally, a second olefinic monomer, such as ethylene or propylene, may be copolymerised with the vinyl acetate and the resulting copolymers hydrolysed to create vinyl alcohol groups in the same manner. The olefinic monomer may be present in an amount from 1 to 50 mol % or 2 to 40 mol % or 5 to 20 mol % of the polymer backbone. The resulting poly(vinyl alcohol) polymers typically have modified water solubility and other physical properties compared with those derived from homopolymers of vinyl acetate. Alternatively, the olefinic monomer may be a vinylic, acrylic or methacrylic monomer, including styrene, acrylonitrile, methacrylonitrile, crotononitrile, vinyl halides, vinylidene halides, (meth)acrylamide, N,N-dimethyl acrylamide, vinyl polyethers of ethylene or propylene oxide, vinyl esters such as vinyl formate, vinyl benzoate or vinyl ethers (such as VeoVa™ 10 available from Momentive™), vinyl ethers of heterocyclic vinyl compounds, alkyl esters of mono-olefinically unsaturated dicarboxylic acids and in particular esters of acrylic and methacrylic acid; vinyl monomers with hydroxyl functionality 2-hydroxy ethyl (meth)acrylate, 2-hydroxy propyl (meth)acrylate, glycerol mono(meth)acrylate, 4-hydroxy butyl (meth)acrylate, hydroxyl stearyl methacrylate, N-methylol (meth)acrylamide; vinyl monomers with additional functionality for cross-linking or adhesion promotion or post functionalization of the vinyl polymers, such as diacetone acrylamide, aceto acetoxy ethyl (meth)acrylate, glycidyl methacrylate, 2-acrylamido-2-methylpropane sulfonic acid, (meth)acrylic acid, beta carboxy ethyl (meth)acrylate, maleic anhydride, styrene sulfonic acid, sodium sulfo propyl methacrylate, itaconic acid; N, N′-dimethyl acrylamine, N-isopropyl acrylamide, N,N-dimethyl ethyl amino (meth)acrylate, N,N-diethyl ethyl amino (meth)acrylate, N,N-dimethyl propyl amino (meth)acrylate, N,N-diethyl propyl amino (meth)acrylate, 4- and 2-vinyl pyridine, amino methyl styrene, crotonic acid, esters of crotonic acid, crotononitrile, vinyl imidazole; and basic amine monomers can be polymerised as the free amine, protonated salts or as a quaternised amine salt. Where a monomer is indicated with a prefix in brackets (e.g. meth) it shall be understood that it be used in a form with or without the methyl substitution, or alternatively an alternative alkyl group may be present. For example, in the case of acrylic acid, methacrylic acid or another derivative such as ethacrylic acid may be used.

In addition it may be envisioned that a PVOH based polymer may conceivably contain ‘PVOH’ as a block within another polymer or copolymer or as grafts to, or from, another polymer or copolymer backbone or as a branched polymer containing short, oligomeric or polymeric cross-links within the polymeric or co-polymeric structure as a whole. A degree of cross linking may be beneficial in order to maintain structural integrity of the coated layer as well as to increase the barrier properties of the layer. Cross-linking may be carried out by any suitable technique which are well known and may include the use of agents such as epoxides, formaldehyes, isocyanates, reactive siloxanes, anhydrides, amidoamines, boric acid and suitably reactive transition metals and derivatives thereof.

It will be appreciated that PVOH may also be prepared by the hydrolysis of other poly(vinyl esters) such as poly(vinyl formate), poly(vinyl benzoate) or poly(vinyl ethers). Similarly a copolymer of vinyl alcohol such as poly(ethylene-vinyl alcohol) may also be prepared by copolymerising the relevant monomer with a vinyl ester other than vinyl alcohol and hydrolysing the resulting polymer for instance. Such polymers are also within the scope of the present invention.

PVOH grades with varying degrees of polymerization and hydrolysis are available under the trade name Poval® (Kuraray Chemicals) and include partly and fully saponified grades. Specific examples of fully saponified Poval® (previously called the Mowiol range) include those known as 3-85, 4-88, 4-98, 6-88, 6-98, 8-88, 10-98, 13-88, 15-99, 20-98 and 30-98 (CAS Nos: 9002-89-5). Specific examples of partly saponified Poval® include those known as 3-85 G4, 4-88 G2, 8-88 G2, 18-88 G2, 23-88 G2, 47-88 G2, 3-85, 4-88, 5-88, 6-88, 8-88, 13-88, 18-88, 23-88, 26-88, 32-88, 40-88, 44-88, 47-88, 30-92, 4-88 LA, 8-88 LA and 40-88 LA (CAS Nos: 23213-24-5). The first number in the nomenclature denotes the viscosity of the 4% aqueous solution at 20° C. as a relative measure for the molar mass of the Mowiol; the second number denotes the degree of hydrolysis of the polyvinyl acetate from which the Mowiol grade is derived. Poval© 3-85, 4-88, 4-98, 6-88 and 10-98 are particularly preferred.

In an embodiment, the water-soluble polymer is a PVOH or PVOH-based polymer having degree of hydrolysis within the range 60-99%. Suitably, the water-soluble polymer is a PVOH or PVOH-based polymer having degree of hydrolysis within the range 80-99%. Such high degree of hydrolysis gives rise to favourable solubility characteristics.

Aqueous solutions of such polymers having improved handling characteristics.

In another embodiment, the water-soluble polymer is a poly(vinyl alcohol)-based polymer in which a portion of the hydroxyl groups have been modified by reaction with a (2-22C) aldehyde. The use of such water-soluble polymers may considerably improve the processing of the catalyst composition with respect to the unmodified PVOH-based polymer. Suitably, the water-soluble polymer is a poly(vinyl alcohol)-based polymer in which a portion of the hydroxyl groups have been modified by reaction with a (2-10C)aldehyde. The degree of modification of the PVOH based polymer may be from about 0.1% to about 50%, by this it is meant that the ‘OH’ portion of the PVOH has been replaced by the given percentage. The person skilled in the art will appreciate that, for example, in the case of the reaction of an aldehyde with ‘PVOH’ for each molar quantity of aldehyde two molar quantities of ‘OH’ are substituted via the acetalation reaction. Hence a 50% modified PVOH will have been reacted with 25% of a suitable aldehyde, and, of course the degree of hydrolysis of the PVOH will dictate the maximum level of substitution possible.

In another embodiment, the modified water-soluble polymer is a PVOH based polymer in which at least a portion of the H atoms of the —OH groups have been exchanged for 2-10C aldehyde groups (i.e. by an ester linkage). Suitably, between 0.1 and 50% of the —OH groups have been exchanged for 2-10C aldehyde groups. More suitably, between 1 and 15% of the —OH groups have been exchanged for 2-10C aldehyde groups. Even more suitably, between 2 and 12% of the —OH groups have been exchanged for 2-10C aldehyde groups.

In another embodiment, the modified water-soluble polymer has a structure that schematically represented by formula (I) shown below:

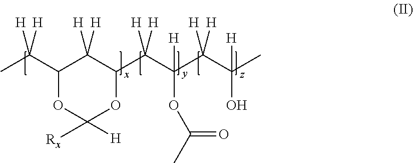

wherein each Rx is (1-9C)alkyl, (2-9C)alkenyl or (2-9C)alkynyl,
x denotes the proportion of modified PVOH monomeric moieties, y denotes the proportion of residual acetate monomeric moieties present polymer following hydrolysis to yield the PVOH, and
z denotes the proportion of unmodified PVOH monomeric moieties.

It will also be understood that formula (II) shows a schematic representation illustrating the structures of the various monomeric moieties that collectively constitute the modified PVOH. Hence, formula (II) does not necessarily imply that the water-soluble polymers are block copolymers or alternating copolymers. On the contrary, monomeric moieties x, y and z may be randomly distributed throughout polymers falling within the scope of formula (II). It will also be understood that PVOH-based polymers falling within the scope of formula (II) may comprise, in addition to monomeric moieties x, y and z, other monomeric moieties.

In another embodiment, the water-soluble polymer is the product formed by reacting a PVOH-based polymer with a 2-10C aldehyde, such that between 0.1 and 50% of the —OH groups are exchanged for 2-10C aldehyde groups. Suitably, the water-soluble polymer is the product formed by reacting a PVOH-based polymer with a 2-10C aldehyde, such that between 1 and 15% of the —OH groups are exchanged for 2-10C aldehyde groups. More suitably, the water-soluble polymer is the product formed by reacting a PVOH-based polymer with a 2-10C aldehyde, such that between 2 and 12% of the —OH groups are exchanged for 2-10C aldehyde groups. Even more suitably, the water-soluble polymer is the product formed by reacting a PVOH-based polymer with a 2-10C aldehyde, such that between 2 and 10% of the —OH groups are exchanged for 2-IOC aldehyde groups. Most suitably, the water-soluble polymer is the product formed by reacting a PVOH-based polymer with a 2-10C aldehyde, such that between 4 and 9% of the —OH groups are exchanged for 2-10C aldehyde groups.

In a yet another embodiment, the water-soluble polymer is a PVOH polymer in which a portion of the available —OH groups have been modified by reaction with butyraldehyde. Such polymers have a structure according to formula (II) wherein Rx is butyl. Suitably, the degree of substitution of the OH groups for such polymers is from 0.1 to 50%. More suitably, the degree of substitution of the OH groups for such polymers is from 1 to 20%. Most suitably, the degree of substitution of the OH groups for such polymers is from 2 to 10%. In an exemplary embodiment, the water-soluble polymer is a PVOH polymer having a degree of hydrolysis of 80-99% that has modified by reaction of 5% or 8% of the available OH groups with butyraldehyde.

Typically poly(vinylalcohol)s (PVOH) polymers are employed, whereby the molecular weight of said polymers are typically between 1,000 and 200,000, and more typically between 20,000 and 100,000, as determined by Gel Permeation Chromatography (GPC) at 20° C., having a viscosity of at 4 wt-% of ca. 2 to 70 mPa·s, measured according to DIN 53015. Aqueous solutions of such polymers have improved handling characteristics.

In an embodiment, the composition comprises between 0.1 and 20 wt-% of the water-soluble polymer. Suitably, the composition comprises between 0.3 and 15 wt-% of the water-soluble polymer. More suitably, the composition comprises between 0.4 and 10 wt-% of the water-soluble polymer. Even more suitably, the composition comprises between 0.5 and 8.0 wt-% of the water-soluble polymer.

In an embodiment, the composition comprises a coating and a part of the water-soluble polymer present in the composition may reside in the coating and the remainder residing outside the coating. If the coating contains a water-soluble polymer this is present for less than 50-wt % in the coating. Suitably, the water-soluble polymer present in the composition is present for less than 25-wt % in the coating. More suitably, the water-soluble polymer is present for less than 10 wt-% in the coating.

In an embodiment the water-soluble polymer is added as an aqueous solution to the composition comprising the absorbent and the ligand salt comprising the ligand of formula (I). The concentration of the water-soluble polymer is between and 50 wt-% in water, more typically between 10 and 30 wt-%. Most typically higher concentrations of the polymer dissolved in water will be preferred.

The coating agent, optionally present in the composition of the first aspect of the invention, comprises preferably water-soluble polymers selected from the classes of poly(vinylpyrrolidone), polyalkylene glycol, poly(vinylalcohol)s, modified poly-(vinylalcohol)s, such as poly-(ethylenevinylalcohol), or polyvinyl acetate and homo- or copolymers prepared from ethylenically unsaturated carboxylic acids, such as polyacrylate. More preferably the water soluble polymers are selected from the classes of polyvinylalcohol or derivatives of polyvinylalcohol, as outlined above. Coating agents may also comprise materials other than the above-mentioned water-soluble polymers, such as starches, alginates, cellulose derivatives, fatty acids, waxes, paraffins, polyethylene glycols, gelating compounds, electrolytes, polyelectrolytes. Also suitable mixtures of any two or more of the above mentioned water-soluble polymers or other materials may be employed as coating agent(s). Therefore, the function of the water solubility of the polymer needed to prepare stable granules according to this invention, this is desirable, but not mandatory to obtain suitable coatings around the granules.

In another and preferred embodiment the composition of the first aspect of the invention does not have a coating.

The absorbent that is included in the compositions is essential to obtain absorbance and/or removal of water upon addition of the aqueous solution comprising the polymer and the solution of the complex. It also aids in binding together the components of the composition, especially during the drying processes. Suitable absorbents are based on polysaccharides, which are polymers of monosaccharides with typical polymer chain lengths of 40-3000 monosaccharides units. Examples of suitable polysaccharides include starch, natural gums, such as alginate, or cellulose, glycogen, chitin, callose, lumarinin, chrysolaminarim, xylan, arabinoxylan, mannan, fucoidan, galactomannan. Also modified polysaccharides, such as modified starch or modified cellulose, may be used. Most suitable as absorbent is a starch, which is a polymer of glucose in which the glucopyranose units are bonded by alpha-linkages. Suitable sources of starch are potato starch, maize starch, rice starch, wheat starch and partially pre-gellatinised starches from the aforementioned list. Alternatively, the absorbent may be a modified starch, such as dextrin, a natural gum, such as alginate. Most suitably, the absorbent is maize starch, potato starch or rice starch. Also particularly suitable are cellulosic materials, such as cellulose fibers, methyl cellulose, hydroxyethyl cellulose, hydroxypropyl cellulose, or carboxy-modified celluloses, such as carboxylmethyl cellulose (CMC). Most suitable is cellulose, in particular microcrystalline cellulose (e.g. Heweten® 101). Natural gums are polysaccharides of natural origin which are capable of causing a large increase in solution viscosity. They are mostly botanical gums, found in the woody elements of plants or in seed coatings. Examples of natural gums are natural gums obtained from seaweeds, e.g. agar, alginic acid, sodium alginate and Carrageenan, or natural gums obtained from non-marine botanical resources, e.g. gum arabic, gum ghatti, gum tragacanth, Karaya gum, guar gum, Locust bean gum, beta-glucan, dammar gum, glucomannan, Psyllium seed husks and Tara gum, or natural gums produced by bacterial fermentation, e.g. gellan gum or xanthan gum.

In an embodiment, the composition comprises 5-75 wt-% of the absorbent. In another embodiment the composition comprises between 8 and 60 wt-% of the absorbent. In yet another embodiment the composition comprises between 10 and 50 wt-% of the absorbent. In an embodiment, the absorbent is added as a solid material having a purity typical of more than 90 wt-% and more typical of more than 95 wt-%.

In one embodiment the composition according to the invention contains at least one of the additional ingredients selected from the group consisting of a filler; a salt; and a bleach activator; and wherein these ingredients are present in the following amounts
0-85 wt-% of a filler;
0-85 wt-% of an inorganic salt;
0-90 wt-% of a bleach activator; wherein

the percentages refer to the total amount of the compositon.

The filler that may be included in the composition can be either an organic filler or an inorganic filler, or a mixture thereof. Suitable organic fillers are different from the polysaccharides used as adsorbent and include saccharides and derivatives thereof, including sugars. Examples of sugars include glucose, dextrose, fructose, galactose, sucrose, lactose, maltose. Also modified saccharides may be used.

In another embodiment the filler is an inorganic filler. Inorganic fillers include talcs, micas, zeolites, silicates, silicas and clays. Suitably, the inorganic filler is selected from talcs, micas, zeolites, and silicates.

In an embodiment the composition comprises between 0 and 85 wt-% of a filler. In another embodiment the composition comprises between 0 and 60 wt-% of a filler. In another embodiment the composition comprises between 0 and 40 wt-% of a filler. In yet another embodiment the composition comprises between 0 and 20 wt-% of a filler. In another embodiment the composition does not contain any filler.

The salt that may be included in the composition are typically alkali metal, alkali earth metal, or transition-metal salts of bicarbonates, carbonates, halides (chloride, bromide or iodide), sulfates, phosphates, oxides, acetates, citrates or nitrates.

In an embodiment the salts comprises one or more salts selected from the group consisting of sodium bicarbonate, sodium sulfate, sodium chloride, sodium nitrate, sodium acetate, sodium citrate, sodium nitrate, potassium sulfate, potassium chloride, potassium citrate, calcium carbonate, calcium chloride and calcium sulfate. Suitably, the inorganic salt comprises one or more salts selected from the group consisting of sodium sulfate, calcium carbonate and sodium citrate.

In a preferred embodiment the salts are water-soluble.

In an embodiment the composition comprises between 0 and 85 wt-% of a salt. In another embodiment the composition comprises between 0 and 60 wt-% of a salt. In another embodiment the composition comprises between 0 and 40 wt-% of a salt. In yet another embodiment the composition comprises between 0 and 20 wt-% of a salt. In another embodiment the composition does not contain any salt.

The composition may also comprise of a bleaching activator. As bleaching activators, the compositions of the invention can contain compounds generally known from the prior art. These are preferably multiple acylated alkylene diamines, in particular tetraacetylethylene diamine (TAED), acylated triazine derivatives, in particular 1.5-diacetyl-2,4-dioxohexahydro-1,3,5-triazine (DADHT), acylated glycolurils, in particular tetraacetylglycoluril (TAGU), glyceroltriacetate (triacetin), N-acylimides, in particular N-nonanoyl succinimide (NOSI), acylated phenolic sulfonates, in particular n-nonanoyloxi- or n-lauroyloxibenzenesulfonate (NOBS or LOBS), acylated phenolic carboxylic acids, in particular nonanoyloxi- or decanoyloxibenzoic acid (NOBA or DOBA, respectively), carboxylic acid anhydrides, in particular phthalic acid anhydride, acylated multivalent alcohols, preferably triacetine, ethyleneglycol diacetate and 2.5-diacetoxy-2,5-dihydrofurane as well as acetylated sorbitol and mannitol or their mixtures, respectively (SORMAN), acylated sugar derivatives, preferably pentaacetylglucose (PAG), pentaacetylfructose, tetraacetylxylose and octaacetyllactose as well as acetylated and optionally N-alkylated glucamine and gluconolactone, and/or N-acylated lactams, for example N-benzoylcaprolactam. Hydrophilic substituted acylacetales and acyllactames can also preferably be used. In addition, nitrile derivatives such as n-methyl-morpholinium acetonitrile-methyl sulfate (MMA) or cyanomorpholine (MOR) can be used as bleaching activators. Combinations of bleaching activators can also be used.

Suitably the composition may comprise TAED, NOBS, triacetin, and DOBA. More suitably the granule may comprise TAED.

In an embodiment, the composition comprises of 0-90 wt-% of the bleaching activator. Suitably the composition comprises of 0-85 wt-% of the bleaching activator. Also suitable is a composition without any bleaching activator. Also suitable is a composition that comprises of 10-85 wt-% of the bleaching activator and more suitably between 20-85 wt-% of the bleaching activator.

The compositions according to the invention are solids and are present as powders or in a shaped form. The compositions can be present, for example, as granules, powders or tablet-shaped solids. Preferred are granules.

The production of the granules according to the invention can be carried out according to methods known per se and has already been described in detail in the above-mentioned patent documents. There are basically different granulation methods available.

In a first preferred process variant, building-up of the granules takes place in a mixing apparatus. The components are processed in usual mixing devices operating batch-by-batch or continuously, which are usually equipped with rotating mixing organs. When mixing, all mixing variants are conceivable, which ensure a sufficient mixing the components.

In a preferred embodiment, all components are mixed at the same time. However, multi-stage mixing processes are also conceivable, in which the individual components are entered in the overall mixture individually or together with other additives in different combinations.

The order of slow and fast mixers can be exchanged according to requirements. The dwell times in the mixer granulation are preferably 0.5 s to 20 min, especially preferred 2 s to 10 min. The granulation fluid can be pumped into the mixing apparatus via simple conduction tubes. For better distribution, however, nozzle systems (single- or multi-material nozzles) are also conceivable.

Typically, a drying step follows the granulation stage to avoid conglutination of the granules. Then, by sieving the coarse grain parts and the fine grain parts are separated. The coarse grain content is crushed by grinding and, like the fine grain content, is fed to a new granulation process. The application of a coating is preferably provided in a fluidized bed apparatus, for example in a fluidized bed mixer.

Solutions are intensively mixed with powdery active substances and other additives optionally present, resulting in a plastically deformable mass. The mixing step can be performed in the above-mentioned mixing apparatus, but also kneaders or special extruder types are conceivable. The granulation mass is then pressed by means of tools through the nozzle holes of a press matrix, creating cylindrically shaped extrudates. The exiting extrudates must be crushed to the desired length or particle size by a post-processing step. In many cases, a length/diameter ratio of L/D=1 is desired. For cylindrical granules, the particle diameter is typically between 0.2 and 2 mm, preferably between 0.5 and 0.8 mm, the particle length is in the range of 0.5 to 3.5 mm, ideally between 0.9 and 2.5 mm. The length or size adjustment of the granules can be obtained, for example, by fixed stripper knives, rotating cut knives, cut wires or blades. To round off the cutting edges, the granules can then be rounded again in a rondier.

After the size adjustment of the granules, often a final solidification step is required in which the solvent is removed and optionally a coating is then applied, if coated granules are desired. This step is usually carried out in a fluidized bed apparatus, which is operated as a dryer, for example in a fluidized bed mixer. From the prepared uncoated of coated granules by sieving the coarse grain part and the fine grain part is separated. The coarse grain content is crushed by grinding and, like the fine grain content, is fed to a new granulation process.

Preferred compositions according to the invention are also characterized by a water content of less than 3% by weight (measured by Karl Fischer), based on the total amount of compositions, especially preferred 0 to 2% by weight.

As will be appreciated by the person skilled in the art, it may be desirable to subject compositions according to the first aspect of the invention to further processing, for example to make granules having beneficial properties, to include in the bleaching formulations of the invention, for example solid detergent formulations. Whilst compositions according to the first aspect of the invention can be included in the bleaching formulations as such owing to their excellent storage stability, the formulator may want to modify these particles further, for example, by mixing with a soluble coating agent.

Accordingly, compositions according to the first aspect of the invention, of a desired particle size, may according to some embodiments be coated with a water-soluble material, which coating may optionally be provided with a water-dispersible surface powder coating. The skilled person is aware of suitable water-soluble materials and water-dispersible surface powder coatings, which are fully described, for example, in WO 95/06710 A1 and WO 95/30733 A1. Also polyvinylalcohol may be additionally employed as coating material, such as described in WO2018/210442.

Thus the bleaching formulation of the invention may be in the form of non-friable granules comprising the composition according to the first aspect of the invention, optionally with additional inert solid, bleach precursor, filler and inorganic salt, and optionally with a coating agent. Definitions and descriptions of each essential and optional class of ingredients are given in the detailed description section above.

The compositions of the first aspect of the invention, optionally in the form of a non-friable granule as described above, may be subjected to grinding, pulverising or the like so as to provide a dried composition having a desired particle size. As is well-known in the art, where such compositions are to be introduced into solid bleaching formulations, such as powders for use in laundry, agglomerated particles comprising bleach-activating catalysts are desirably of approximately the same size and bulk density as the other components of a solid bleaching formulation, so as to avoid segregation by percolation or floating.

The composition of the first aspect of the invention or a composition made therefrom is typically present in bleaching formulations according to the third aspect in a solid, generally particulate, form (for example as granules or powder), with mean particle sizes typically between 50 and 2500 μm, for example between 100 and 1600 μm. Particle sizes may be measured by a laser diffraction particle size analyser, for example a Malvern HP equipped with a 100 mm lens.

Bulk density and size of the granules can be controlled via the composition, the process condition or both, as is known in the art.

The skilled person is well acquainted with suitable particle sizes and densities (and/or can determine appropriate sizes and densities through routine experimentation), and with suitable techniques to achieve these, for example through conventional granulation techniques. For example, suitable particles may be prepared by any conventional and/or known granulation techniques, such as using a pan granulator, fluidised bed, Schugi mixer, Lödige ploughshare mixture, rotating drum and other low energy mixers; by compaction, including extrusion and tabletting optionally followed by pulverising and grinding; when melt binding agents are used by prilling and pastilling using a Sandvik Roto Former; and by high shear-energy process using a high-speed mixer/granulator equipment having both a stirring action of high energy and a cutting action. An example of a suitable compactor is equipment from Hosokawa, e.g. Bepex L200/30. Examples of such high-speed mixture/granulator equipment are the Fukae™, FS-G mixture manufactured by Fukae Powtech Kogyo Co, Japan. Other mixers usable in the process of the invention include the Diosna™, ex T. K. Fielder Ltd UK; the Fuji™ VG-C Series ex Fuji Sangyo Co. Japan; and the Roto™ ex Zanchete & Co S.r.l. Italy. Besides batch equipment, it is also possible to use a high speed mixer/granulator such as the Lödige Recycler.

The compositions of the invention are preferably available as granular or tablet-shaped preparations which can be prepared in a known manner, for example by mixing, granulating, roll compacting and/or by spray drying of the thermally resilient components and then by adding the more sensitive components, for example enzymes, bleaching agents, manganese(II) acetate and the ligand salt.

For the preparation of the cleaning agents according to the invention in tablet form, preferably all components are combined in a mixer and mixed with each other. Subsequently, the mixture is compacted by means of conventional tablet presses, for example using eccentric presses or rotary presses with pressures in the range between 200×10⁵ Pa and 1500×10⁵ Pa.

One thus obtains easily break-resistant tablets which are under application conditions sufficiently quickly soluble and which have flexural strengths of normally more than 150 N. Preferably, a tablet produced in this way has a weight of 15 to 40 g, in particular from 20 to 30 g, with a diameter of 35 to 40 mm.

The preparation of the compositions of the invention in the form of non-dusting, storage-stable and free-flowing granules with high bulk densities in the range of 800 to 1000 g/L can be carried out in that in a first process sub-stage the builder components are mixed with at least a proportion of liquid mixture components by increasing the bulk density of this premixture and subsequently—if desired after an intermediate drying—the further components of the composition, including the bleach catalyst, are combined with the thus obtained premixture.

Appropriate conditions such as durations of and temperatures for the contacting will depend on the nature of the reactants (the salt of the compound L or L-BG-L, Mn(II) acetate, and other ingredients to obtain suitable granules) and their quantities and can be established without undue burden by the skilled person. For example, durations of contacting may be between about 1 min and about 24 hours. Often, the contacting can be carried out at ambient temperature, for example at about 20 to 25° C. although elevated temperatures, for example between about 25 and about 50° C. may be used if desired.

The compositions of the first aspect of the invention, optionally in the form of non-friable granules as described above, are typically subjected to compaction, grinding, pulverising or the like so as to provide a dried composition having a desired particle size. As is well-known in the art, where such compositions are to be introduced into solid bleaching formulations, such as granules for use in laundry, agglomerated granules comprising bleach-activating catalysts are desirably of approximately the same size and bulk density as the other components of a solid bleaching formulation, so as to avoid segregation by percolation or floating.

Preferred is a method of manufacturing a bleaching catalyst composition, said method comprises the steps of:
a) providing in a mixing device a composition containing a water soluble polymer as defined above, an absorbent, water, a salt of composition [HL]⁺(Xⁱ⁻)_{1/i}, [H₂L]²⁺ (Xⁱ⁻)_{2/i}, H₃L]³⁺ (Xⁱ⁻)_{3/i}, [(HL-BG-LH)]²⁺ (Xⁱ⁻)_{2/i}, [(HL-BG- LH₂)]³⁺ (Xⁱ⁻)_{3/i}, [(H₂L-BG-LH₂)]⁴⁺ (Xⁱ⁻)_{4/i}, [(H₃L-BG-LH₂)]⁵⁺ (Xⁱ⁻)_{5/i}, and/or [(H₃L-BG-LH₃)]⁶⁺ (Xⁱ⁻)_{6/i}, whereby L, BG, i and Xⁱ⁻ are as defined above, Mn(II) acetate, and optionally the filler, optionally the salt and optionally the bleach activator;
b) mixing the ingredients of said composition
c) forming particles; and
d) optionally drying the particles resulting from step c).

In a variant of the method of manufacturing a bleaching catalyst composition comprising steps a) to d) the dried particles or granules are further subjected in a step e) to a coating process.

The composition according to the first aspect of the invention are typically present in bleaching formulations according to the third aspect in a solid, generally particulate, form (for example as granules), with mean particle sizes typically between 50 and 2500 μm, for example between 100 and 1600 μm. Particle sizes may be measured by a laser diffraction particle size analyser, for example a Malvern HP equipped with a 100 mm lens.

Bulk density and size of the granules can be controlled via the composition, the process condition or both, as is known in the art.

The composition according to the first aspect of the invention, i.e. those comprising Mn(II) acetate, polysaccharide absorbent, water soluble polymer and salts of compound L or L-BG-L described herein, are of particular use when used in bleaching formulations. The composition serves to catalyse the oxidising activity of a peroxy compound, which may either be included within a bleaching formulation according to the present invention, or may be generated from such a bleaching formulation in situ.

Where a peroxy compound is present in a bleaching formulation comprising compositions of the invention, preferably in the shape of granules, this may be, and typically is, a compound which is capable of yielding hydrogen peroxide in aqueous solution. Suitable amounts of peroxy compounds included within the bleaching formulation may be determined by the skilled person although typical quantities will be within the range of 1-35 wt %, for example 5-25 wt %, based on the solids content of the bleaching formulation. One of skill in the art will appreciate that smaller quantities of peroxy compounds may be used where the bleaching formulation comprises a bleaching system (discussed below) comprising a peroxy compound and a so-called bleach precursor.

Suitable hydrogen peroxide sources are well known in the art. Examples include the alkali metal peroxides, organic peroxides such as urea peroxide, and inorganic persalts, such as alkali metal perborates, percarbonates, perphosphates, persilicates, and persulfates. Typical peroxy compounds included within bleaching formulations are persalts, for example optionally hydrated sodium perborate (e.g. sodium perborate monohydrate and sodium perborate tetrahydrate) and sodium percarbonate. According to particular embodiments, the bleaching formulation comprises sodium perborate monohydrate or sodium perborate tetrahydrate. Inclusion of sodium perborate monohydrate is advantageous owing to its high active oxygen content. Use of sodium percarbonate is most advantageous for environmental reasons.

Organic peroxy acids may also serve as the peroxy compound. These may be mono- or diperoxyacids. Typical mono- or diperoxyacids are of the general formula HOO—(C═O)—R—Z, wherein R is an alkylene or substituted alkylene group containing from 1 to about 20 carbon atoms, optionally having an internal amide linkage or a phenylene or substituted phenylene group; and Z is hydrogen, halogen, alkyl, aryl, an imido-aromatic or non-aromatic group, a COOH or (C═O)OOH group or a quaternary ammonium group.

Typical monoperoxy acids include peroxy benzoic acids, peroxy lauric acid, N,N-phtaloylaminoperoxy caproic acid (PAP) and 6-octylamino-6-oxo-peroxyhexanoic acid. Typical diperoxy acids include for example: 1,12-diperoxydodecanoic acid (DPDA) and 1,9-diperoxyazeleic acid.

As well as organic peroxyacids, inorganic peroxyacids are also suitable, for example potassium monopersulfate (MPS).

If organic or inorganic peroxyacids are included within bleaching formulations, the amount of them incorporated in a bleaching formulation will typically be within the range of about 2-10 wt %, for example 4-8 wt %.

The bleaching formulation need not comprise a peroxy compound, however: a bleaching formulation of the invention may instead comprise a bleaching system constituted by components suitable for the generation of hydrogen peroxide in situ, but which are not themselves peroxy compounds. An example of this is the use of a combination of a C₁₋₄ alcohol oxidase enzyme and a C₁₋₄ alcohol, for example a combination of methanol oxidase and ethanol. Such combinations are described in WO 95/07972 A1 (Unilever N.V. and Unilever plc).

Often, a bleaching species is generated in situ. For example, organic peroxyacids are often generated in situ, as opposed to being included within the bleaching formulation, peroxyacids themselves tending to be insufficiently stable. For this reason, bleaching formulations often comprise a bleaching system comprising a persalt (e.g. sodium perborate (optionally hydrated) or sodium percarbonate), which yields hydrogen peroxide in water; and a so-called peroxy bleach precursor capable of reacting with the hydrogen peroxide to generate an organic peroxyacid.

The skilled person is very familiar with the use of bleaching systems comprising peroxy bleach precursors, peroxy bleach precursors being well known to the skilled person and described in the literature. For example, reference in this regard is made to British Patents 836988, 864,798, 907,356, 1,003,310 and 1,519,351; EP 0 185 522 A, EP 0 174 132 A, EP 0 120 591 A; and U.S. Pat. Nos. 1,246,339, 3,332,882, 4,128,494, 4,412,934 and 4,675,393. Suitable bleach precursors have been listed above.

Where used, bleach precursor compounds are typically present in the bleaching formulation in an amount of up to 12 wt %, for example from 2-10 wt %, of the composition, based on the solids content of the bleaching formulation.

Peroxy compounds or bleaching systems as described herein can be stabilised within the bleaching formulation by providing them with a protective coating, for example a coating comprising sodium metaborate and sodium silicate.

For automatic dishwash cleaning, corrosion on glassware during the rinsing stages can be suppressed by using glass corrosion inhibitors. These are, for example, crystalline layered silicates and/or zinc salts. Crystalline layered silicates are available for example from WeylChem under the trade name of SKS-6 (δ-Na₂Si₂O₅). Other known crystalline layered silicates are e.g. Na—SKS-1 (Na₂Si₂₂O₄₅-xH₂O, kenyaite), Na—SKS-2 (Na₂Si₁₄O₂₉-xH₂O, magadiite), Na—SKS-3 (Na₂Si₈O₁₇-xH₂O), Na—SKS-4 (Na₂Si₄O₉-xH₂O, makatite), Na—SKS-5 (α-Na₂Si₂O₅), Na—SKS-7 (β-Na₂Si₂O₅, natrosilite), Na—SKS-9 (NaHSi₂O₅·H₂O), Na—SKS-10 (NaHSi₂O₅˜3H₂O, kanemite), Na—SKS-11 (t-Na₂Si₂O₅) and Na—SKS-13 (NaHSi₂O₅). An overview of crystalline sheet-silicates is found, for example, in the article published in “Seifen-Öle-Fette-Wachse, volume 116, No. 20/1990”, on pages 805-808.

In a further preferred embodiment of the invention, the washing and cleaning compositions of the present invention, in particular the dishwasher detergents, incorporate the crystalline layered silicate at preferably 0.1 to 20 wt %, more preferably 0.2 to 15 wt % and more preferably 0.4 to 10 wt %, all relative to the overall weight of the composition.

To control glass corrosion, washing and cleaning compositions of the present invention, in particular dishwasher detergents, may incorporate at least one zinc or bismuth salt, preferably selected from the group of organozinc salts, more preferably selected from the group of soluble organozinc salts, yet more preferably selected from the group of soluble zinc salts of monomeric or polymeric organic acids and yet still more preferably selected from the group consisting of zinc acetate, zinc acetylacetonate, zinc benzoate, zinc formate, zinc lactate, zinc gluconate, zinc oxalate, zinc ricinoleate, zinc abietate, zinc valerate and zinc p-toluenesulfonate. Bismuth salts such as, for example, bismuth acetates are employable as an alternative to or in combination with these zinc salts.

Preference in the context of the present invention is given here to washing and cleaning compositions, in particular dishwasher detergents, where the amount of zinc salt, relative to the overall weight of this composition, is from 0.1 to 10 wt %, preferably from 0.2 to 7 wt % and more preferably from 0.4 to 4 wt %, irrespective of which zinc salts are used, specifically irrespective that is as to whether organic or inorganic zinc salts, soluble or insoluble zinc salts or mixtures thereof are used.

Cleaning agents of the invention may also contain silver corrosion inhibitors for silver corrosion control. Preferred silver corrosion inhibitors are organic sulfides such as cystine and cysteine, di- or trihydric phenols, optionally alkyl- or aryl-substituted triazoles such as benzotriazole, isocyanuric acid, salts and/or complexes of titanium, of zirconium, of hafnium, of cobalt or of cerium wherein the metals referred to are present in one of the oxidation states II, Ill, IV, V or VI, depending on the metal.

According to particular embodiments, bleaching formulations may be used for bleaching and/or modifying (e.g. degrading) polysaccharides (for example cellulose or starch) or polysaccharide-containing (for example cellulose-containing, also referred to herein as cellulosic) substrates. Cellulosic substrates are found widely in domestic, industrial and institutional laundry, wood-pulp, cotton processing industries and the like. For example, raw cotton (gin output) is dark brown in colour owing to the natural pigment in the plant. The cotton and textile industries recognise a need for bleaching cotton prior to its use in textiles and other areas. The object of bleaching such cotton fibres is to remove natural and adventitious impurities with the concurrent production of substantially whiter material.

Irrespective of the nature of the substrate treated in accordance with the method of the fourth aspect of the invention, it is the objective when doing so to effect bleaching, i.e. to remove unwanted chromophores (be they, for example, stains or solids on cloth in laundering or dishwashing applications; residual lignin in wood pulp or polyphenolic materials present in raw cotton and wood pulp and paper) and/or to degrade material, for example starch or polyphenolic materials in dishwashing. According to particular embodiments, therefore, the substrate may be a dirty dish or a polysaccharide- or polysaccharide-containing substrate, for example wherein the polysaccharide is a cellulosic substrate, such as cotton, wood pulp, paper or starch.

The bleaching formulation of the present invention may thus be used in a method of dishwashing. Such a method typically involves cleaning dishes in a mechanical dishwasher, often to remove starch and polyphenolic components from the dishes' surfaces. The term “dishes” herein embraces within its scope cookware as well as plates, crockery and other eating (e.g., cutlery) and serving tableware, for example items made of ceramic, metallic or plastics materials. Accordingly, embodiments of the fourth aspect of the invention include methods of cleaning dishes in a mechanical dishwasher, which comprise contacting the dishes with water and a bleaching formulation in accordance with the third aspect of the invention.

Although it is to be understood that the invention is not to be considered to be so limited, where a bleaching formulation is intended for use in hard-surface cleaning applications, the bleaching formulation will typically comprise other components well understood by those of normal skill in the art, such as bleach stabilisers (also known as sequestrants), for example organic sequestrants such as aminophosphonate or carboxylate sequestrants; one or more surfactants, for example cationic anionic or non-anionic (amphiphilic) surfactants; as well as other components, including (but not limited to) detergency builders, enzymes and perfuming agents.

A bleaching formulation according to the third aspect of the invention, will contain preferably between 0.1 and 50 wt-% of one or more surfactants. This bleaching formulation may comprise one or more anionic surfactants and one or more non-ionic surfactants. In general the anionic and nonionic surfactants of the surfactant system may be chosen from the surfactants described in “Surfactant Active Agents, Vol 1 by Schwartz & Perry, Interscience 1949, vol 2 by Schwartz, Perry & Berch, Interscience 1958; in the current edition of “McCutcheon's Emulsifiers and Detergents” published by Manufacturing Confectioners Company; or in Tenside Taschenbuch, H. Stache, Carl Hauser Verlag, 1981. Examples of descriptions of suitable anionic and nonionic surfactants can for example be found in WO 03/072690 A1 (Unilever N. V. et al.), WO 02/068574 A1 (Unilever N. V. et al.) and WO 2012/048951 A1 (Unilever PLC et al.)

Those knowledgeable of bleaching formulations will be familiar with the use of enzymes in this context. Enzymes can provide cleaning performance, fabric care and/or sanitation benefits. Said enzymes include oxidoreductases, transferases, hydrolases, lyases, isomerases and ligases. Members of these enzyme classes are described in Enzyme Nomenclature 1992: Recommendations of the Nomenclature Committee of the International Union of Biochemistry and Molecular Biology on the Nomenclature and Classification of Enzymes, 1992, ISBN 0-1202271165-3, Academic Press. Detersive enzymes are described in greater detail in for example U.S. Pat. No. 6,579,839 (Price et al.).

Suitable detergency builders as optional ingredients may also be present, for example as described in WO 00/34427 A1. Builders may include aluminosilicates, in particular zeolites, e.g. zeolite A, B, C, X and Y types, as well as zeolite MAP as described in EP 0 384 070 A; and precipitating builders such as sodium carbonate. Such builders are typically present in an amount from about 5 to about 80 wt-%, more preferably from about 10 to 50 wt-%, based on the solids content of the bleaching formulation.

The skilled person will be readily able to formulate a suitable bleaching formulation for use in dishwash cleaning or laundry cleaning in accordance with his normal skill. Likewise, the skilled person will be readily able to formulate bleaching formulations suitable for use in the other applications described herein. Such formulations may, for example, comprise additional metal-ion based bleach catalysts or organic bleach catalysts suitable for catalysing the activity of the peroxy compounds described herein. Non-limiting examples of transition-metal based bleaching catalysts can be found for example in EP 2 228 429 A1 (Unilever PLC and Unilever N. V.), and references cited therein and examples of organic catalysts can be found in WO 2012/071153 A1 (The Procter & Gamble Company).

The invention also relates to a cleaning method said method comprising contacting a substrate to be cleaned with water and a bleaching formulation as defined hereinto before.

Preferably the cleaning method is a method of cleaning dishes, in particular by using a mechanical dishwasher, the method comprising contacting the dishes to be cleaned with water and the bleaching formulation as defined hereinto before.

Also preferred is a method of cleaning textiles or non-woven fabrics, the method comprising contacting the textiles or the non-woven fabrics to be cleaned with water and the bleaching formulation as defined hereinto before.

The non-limiting examples below more fully illustrate the embodiments of this invention.

### EXPERIMENTAL

Chemicals Used

Mn(CH₃COO)₂ tetrahydrate, Mn(II)Cl₂ tetrahydrate, Mn(II)SO₄ hydrate, and sodium carbonate were obtained from Sigma Aldrich.

Mn(CH₃COO)₂ tetrahydrate for granule 5 was obtained from Carl Roth GmbH (Germany).

Mn-oxalate.dihydrate was obtained from Weylchem Performance Products. [H₂(Me₃TACN)](HSO₄)₂ (=[H₂L)](HSO₄)₂) was prepared as described in WO2022/122117.

[H₂(Me₃TACN)]Cl₂ (=[H₂L)]Cl₂) prepared as described in WO2022/122117. Corn starch was obtained from Roth.

TAED (Peractive® AC White) was obtained from Weylchem Performance Products.

MnTACN coated granules (Weyclean® FDO XP) was obtained from Weylchem Performance Products. MnTACN stands for [Mn^{IV}₂(μ-O)₃(Me₃-TACN)₂](PF₆)₂·H₂O.

Polyvinyl alcohol was obtained from Kuraray, under the trade name Poval® 6-88.

Trisodium citrate was obtained from Jungbunzlauer.

Sodium percarbonate was obtained from Solvay.

SKS-6 silicate (Weylclean® SKS-6) was obtained from Weylchem Performance Products.

PEG 1500 and PEG 6000 powder were obtained from Clariant.

Sokalan® PA25 Cl and Lutensol were obtained from BASF.

Protease Blaze Evity 150T and Amylase Stainzyme Plus Evity 24T were obtained from Novozymes.

Preparation of Qranules and ADW Tablets

A typical recipe to prepare the granules according to the table below is as follows (example given for granule 1 and granule 2).

Granule 1: In an Eirich laboratory mixer (Type R₀₂), 35.67 g of water, 4.44 g of Poval® 6-88, 2.68 g of [H₂(Me₃TACN)](HSO₄)₂, 2.21 g of Mn(CH₃COO)₂ tetrahydrate, 37.5 g of corn starch, and 200 g of TAED were added and mixed thoroughly at room temperature. Subsequently, the mixture was brought into a Retsch AS 200 dryer and dried at 90° C. The resulting white and uncoated granules are sieved at 200 μm and 1600 μm. Overall yield was 80.2% (the remaining 19.8% were the fine particles (<0.2 mm) or coarse particles that can be used again for the compaction as described above). Visual inspection showed nearly colourless (off white) particles.

Granule 2: Similarly, 2.2 g [H₂Me₃TACN](HSO₄)₂ and 1.5 g of Mn(CH₃COO)₂ tetrahydrate (and the other ingredients at the same amounts as what was described above for granule 1), were used to make the uncoated granules, following the same procedure as described above for granule 1.

As a reference a similar granule as granule 1 or 2 was prepared but now no PVOH polymer was added to the aqueous solution containing starch, Mn(CH₃COO)₂ tetrahydrate and ligand salt, but instead the PVOH polymer was used as a coating material. After obtaining the granules, they were coated by using a Fluisied Bed Glatt coater (GPCG 1.1) (granule 3 in Table 1).

Further a commercial coated granule containing 2 wt % of MnTACN (Weyl-clean® FDO XP) was used as reference as well (granule 4 in Table 1). Dishwash tablets comprising reference granules 3 and 4 were used to compare activity and stability of dishwash tablets comprising the granules 1 and 2.

A similar approach as followed to make granules 1 or 2 to attempt to prepare granules comprising the same ligand salt and Mn(II) oxalate, Mn(II) chloride, or Mn(II) sulfate resulted in precipitations of these manganese salts in the mixture of PVOH polymer, water, and ligand salt. Therefore, no granules with these manganese salts could be prepared.

TABLE 1
Composition of granules according to the invention (granules
1 and 2) and of reference granules 3 and 4.

| | | Granule 3 | Granule 4 |
|---|---|---|---|
| Granule 1 | Granule 2 | (Reference) | Reference) |
| Mn(II) acetate | Mn(II) acetate | Mn(II) acetate | Weylclean ® |
| 0.90 wt-% | 0.61 wt-% | 2.43 wt-% | FDO XP |
| | | | (MnTACN) |
| [H₂L](HSO₄)₂ | [H₂L](HSO₄)₂ | [H₂L](HSO₄)₂ | |
| 1.09 wt-% | 0.90 wt-% | 2.43 wt-% | |
| Corn Starch | Corn Starch | Corn Starch | |
| 15.19 wt-% | 15.27 wt-% | 14.55 wt-% | |
| TAED | TAED | TAED | |
| 81.03 wt-% | 81.42 wt-% | 77.60 wt-% | |
| PVOH | PVOH | PVOH coating | |
| 1.80 wt-% | 1.81 wt-% | 3.0 wt-% | |

L stands for Me₃TACN or 1,4,7-trimethyl-1,4,7-triazacyclonane.

The composition of the ADW formulation, to which the granules comprising the manganese and ligand salts were added, is given in Table 2 below.

The various granules whose composition is shown in Table 1 were subsequently treated as follows.

Each of the granule (120 mg for granule 1, 200 mg for granule 2, 100 mg for granule 3, and 100 mg for granule 4) was brought into a vessel that contained the ADW ingredients as indicated in Table 2 below (19.8 g) and the ADW ingredients and the granular material were mixed well. Tablets of 20 g each were prepared by using a Carver Handtablettenpresse Model 4332 using a 1.5 ton press force.

The tablets containing the granules 1, 2 and 3 were white/off-white whilst the tablets containing granule 4 showed spots of the reddish or pink-reddish MnTACN containing granules.

TABLE 2
Composition of Automatic Dishwash Machine (ADW) formulation.

| Ingredient ADW formulation | wt-% |
|---|---|
| Sodium citrate | 36 |
| Sodium carbonate | 25 |
| Sodium percarbonate | 15 |
| Weylclean SKS-6 | 5 |
| Peractive ® AC White | 5 |
| PEG 1500 Powder | 3 |
| PEG 6000 Powder | 2 |
| Sokalan PA25 Cl | 5 |
| Lutensol TO7 | 1 |
| Protease Blaze Evity 150T | 1.5 |
| Amylase Stainzyme Plus Evity 24T | 0.5 |

Cleaning Tests

The various tablets comprising the granules with Mn and ligand salts were tested for tea-stain removal of tea cups in an automatic dishwasher (Miele G 1223 SC GSL2) using said ADW formulation comprising the granules (45° C., standard programme R-time 2, at 21° DH water hardness, with 50 g of IKW soil-protocol. The assessment of the cleaning performance was made based on visual inspection, where 0% means no cleaning of the tea stains and 100% means complete removal of the tea stains.

All formulations comprising the granules 1-4 showed a very good cleaning performance under these conditions (complete cleaning of the tea cups, score of 10 on a scale of 1-10). The blank (no ligand and Mn salt present in the formulation) showed a performance of 4.8 on the same scale.

Storage Stability Tests

The tablets comprising granules 1 and 2 and granule 4 were stored in an oven during 12 weeks at 40° C. and were then both tested for the cleaning performance and visually assessed (colour changes of the tablets). The tablets comprising granule 3 were stored in an oven during 2 weeks at 50° C.

The ADW tablets with granules 1 and 2 (Mn(II) acetate and ligand salt) did not change colour during this storage period (remained white). The ADW tablets with granule 3 showed formation of brown speckles, indicating that the Mn(Ill) salt has been oxidised to MnO₂ species during the storage conditions/period. The tablets with granule 4 showed formation of brownish spots, indicating that the MnTACN compound originally present in granule 4, has been at least partly decomposed to MnO₂ species.

The bleach performance on the tea cups as described above, showed after storage of the tablets containing granules 1 and 2 respectively 10 and 9-10 cleaning. The ADW tablets with granule 3 showed after a much shorter storage time at 50 C, a cleaning performance of 7, and with granule 4 the cleaning performance was 8.

Preparation of Granule 5

Granule 5 had the Following Composition:
Mn(II)acetate: 0.61 wt-%
[H₂L]Cl₂: 0.9 wt-%
Corn starch: 15.27 wt-%
TAED: 81.42 wt-%
PVOH: 1.81 wt-%

Granule 5 was prepared similarly to granule 1. Thus, 2.2 g [H₂Me₃TACN]Cl₂ and 1.5 g of Mn(CH₃COO)₂ tetrahydrate and the other ingredients at the same amounts as what was described for granule 2) were used to make the uncoated granules, following the same procedure as described for granule 1.

Preparation of the ADW Tablets

ADW tablets were prepared using the same ingredients in the same amounts as described for granules 1-4, whereby 200 mg of granule 5 was used to prepare the ADW tablets of each 2 g.

Cleaning Tests

The cleaning tests were carried out as described for the ADW tablets comprising granules 1-4.

The score was 10 (out of 10), like seen with the other granules.

Storage Stability Tests

After storage for 12 weeks at 40° C., the ADW tablets containing granule 5 were still white (i.e. no indication of the formation of MnO₂ during storage).

Furthermore, the cleaning performance remained excellent (score 10 out of 10).

### CONCLUSION

Granules of contain [H₂Me₃TACN]Cl₂ and Mn(II)acetate exhibit high tea-stain removal activity in ADW tablets and they also show an excellent storage stability. The test results are the same as when using analogous granules comprising [H₂Me₃TACN](HSO₄)₂.

Therefore, different protonated ligand salts can be used in conjunction with Mn(II)acetate to obtain active and stable granules.

These data showed clearly that the combination of Mn(II) acetate and Me₃TACN ligand salt mixed in a solution containing PVOH polymer gives surprisingly highly stable granules that showed optimal cleaning performance after 12 weeks storage at 40° C. in ADW tablets. In contrast, granules with other Mn(II) salts, such as Mn(II) oxalate or Mn(II) sulfate could not be prepared due to the poor solubility of these manganese(II) salts in the aqueous solutions containing PVOH.

It was unexpected that the solubility of Mn(II) acetate in an aqueous PVOH solution is much higher than the solubility of Mn oxalate and Mn sulfate in the same PVOH solution, especially considering that both Mn(II) acetate (700 g/L) and Mn(II) sulfate (520 g/L for the monohydrate) are both very well soluble in water.

The high storage stability of the uncoated granules of this invention is even more surprising if one considered that coated granules with PVOH with nearly the same composition (Mn(II) acetate and [H₂L](HSO₄)₂), but without PVOH within the granule, show an inferior storage stability, especially if in the art it is customary to prepare coated granules to improve storage stability in detergent formulations.

1. An uncoated or coated composition containing a water-soluble polymer, wherein the polymer has a solubility in water of at least 50 g/L at 25° C. and is selected from the classes of poly(vinylpyrrolidone), polyalkylene glycol, poly(vinylalcohol)s, modified poly-(vinylalcohol)s, polyvinyl acetate and homo- or copolymers prepared from ethylenically unsaturated carboxylic acids, a polysaccharide absorbent, a salt of composition [HL]⁺(Xⁱ⁻)_{1/i}, [H₂L]²⁺ (Xⁱ⁻)_{2/i}, [H₃L]³⁺ (Xⁱ⁻)_{3/i}, [(HL-BG-LH)]²⁺ (Xⁱ⁻)_{2/i}, [(HL-BG-LH₂)]³⁺ (Xⁱ⁻)_{3/i}, [(H₂L-BG-LH₂)]⁴⁺ (Xⁱ⁻)_{4/i}, [(H₃L-BG-LH₂)]⁵⁺ (Xⁱ⁻)_{5/i}, and/or [(H₃L-BG-LH₃)]⁶⁺ (Xⁱ⁻)_{6/i}, wherein
L is a monocyclic triamine,
BG is a divalent organic bridge group,
i is 1 or 2, and Xⁱ⁻ is a mono- or divalent anion,
0.02-25 wt-% of Mn(II) acetate,
0.02-25 wt-% of said salt, and, provided the composition contains a coating, said water-soluble polymer having a solubility of at least 50 g/L in water at 25° C., is present in the coating for less than 50 wt-%.

2. The composition of claim 1, wherein L is a ring of formula (I) or L-BG-L is two rings of formula (I) linked via an organic divalent group RB: 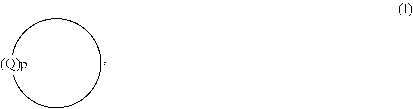
wherein: 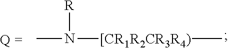
p is 3;
R is independently selected from the group consisting of hydrogen, C₁-C₂₄-alkyl, CH₂CH₂OH and CH₂COOH; or one R is linked as a divalent group RB to the nitrogen atom of another Q of another ring of formula (I), wherein RB is selected from a C₂-C₆ alkylene bridge, a C₆-C₁₀ arylene bridge or a bridge comprising one or two C₁-C₃ alkylene units and one C₆-C₁₀ arylene unit, which bridge may be optionally substituted one or more times with independently selected C₁-C₂₄ alkyl groups;
R₁, R₂, R₃, and R₄ are independently selected from H, C₁-C₄alkyl and C₁-C₄-alkylhydroxy; and whereby
Xⁱ⁻ is selected from Cl⁻, Br⁻, I⁻, NO₃⁻, ClO₄⁻, PF₆⁻, BF₄⁻, OCN⁻, SCN⁻, SO₄²⁻, R′SO₄⁻, R′COO⁻, R″oxalate-, oxalate²⁻, CF₃SO₃⁻ and R′SO₃⁻, whereby
R′ is selected from hydrogen, C₁-C₈ alkyl, phenyl and methyl substituted phenyl, and whereby
R″ is selected from H, Na, K and Li.

3. The composition of claim 2, wherein L is 1,4,7-trimethyl-1,4,7 triazacyclononane (Me₃-TACN) and L-BG-L is 1,2-bis(4,7-dimethyl-1,4,7-triazacyclonon-1-yl)-ethane (Me₄DTNE).

4. The composition according to claim 1, wherein X⁻ is selected from Cl⁻, hydrogen oxalate and HSO₄⁻.

5. The composition according to claim 1, wherein the water-soluble polymer is soluble in water of 25° C. at a concentration of at least 100 g/L.

6. The composition according to claim 1, wherein the water-soluble polymer is present between 0.1-20 wt % and wherein the polysaccharide absorbent is present between 5-75 wt %.

7. The composition according to claim 1, wherein the composition contains at least one of the additional ingredients selected from the group consisting of a filler; a salt; and a bleach activator; and wherein these ingredients are present in the following amounts
0-85 wt-% of a filler;
0-85 wt-% of an inorganic salt;
0-90 wt-% of a bleach activator; wherein
the percentages refer to the total amount of the composition.

8. The composition according to any claim 1, wherein the polysaccharide absorbent is selected from the group consisting of starch, modified starch, cellulose, natural gum, alginate or a combination thereof.

9. The composition according to claim 1, wherein the water-soluble polymer is selected from the group consisting of poly(vinylpyrrolidone), polyalkylene glycol, poly(vinylalcohol)s, modified poly-(vinylalcohol)s and polyacrylate.

10. The composition according to claim 9, wherein the water-soluble-polymer is selected from the group consisting of polyvinyl alcohol or polyvinylalcohol derivative.

11. The composition according to claim 1, wherein the composition contains a coating and the water-soluble polymer is present in the coating in less than 10 wt-%.

12. The composition according to claim 1, wherein the composition contains no coating.

13. The composition according to claim 1, wherein the composition is in the form of a granule.

14. The composition according to claim 7, wherein the filler is selected from the group consisting of an organic filler which is not an absorbent and an inorganic filler.

15. The composition according to claim 7, wherein the bleach activator is tetraacetylethylenediamine (TAED).

16. A bleaching formulation comprising a composition of claim 1 and a peroxy compound or a precursor of a peroxy compound.

17. A cleaning agent comprising a bleaching formulation of claim 16.

18. A method of manufacturing a composition as defined in claim 1, said method comprising
a) providing in a mixing device a composition containing a water-soluble polymer as defined in claim 1, a polysaccharide absorbent, water, a salt of the composition comprising the monocyclic triamine as defined in claim 1, and manganese(II) acetate,
b) mixing the ingredients of said composition; and
c) forming particles or extrude said mixed ingredients as an extrudate, and d) optionally drying the composition resulting from step c).

19. The method of claim 18, wherein the composition comprises between 0.1 and 20 wt-%, referring to the total amount of the composition, of the water-soluble polymer and wherein the water-soluble polymer is added as an aqueous solution to the composition comprising the polysaccharide absorbent, water, the solution comprising the salt comprising monocyclic triamine, manganese(II) acetate, wherein the concentration of the water-soluble polymer is between 5 and 50 wt-%, referring to the aqueous solution of the water-soluble polymer.

20. A dishwashing agent comprising a bleaching formulation of claim 16.
